(19) United States
(12) Patent Application Publication
(10) Pub. No.: US 2001/0055079 A1
(43) Pub. Date: Dec. 27, 2001

(54) Liquid crystal device, liquid crystal display device, and display panel

(76) Inventors: Koji Noguchi, Kanagawa (JP); Hirohide Munakata, Kanagawa (JP); Ryuichiro Isobe, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/826,894

(22) Filed: Apr. 6, 2001

(30) Foreign Application Priority Data
Apr. 13, 2000 (JP) 112215/2000
Mar. 15, 2001 (JP) 074089/2001

(51) Int. Cl. G02F 1/1347; G02F 1/1335; G02F 1/1337

(52) U.S. Cl. 349/75; 349/76; 349/123

(57) ABSTRACT

A liquid crystal device comprises two substrates with nematic liquid crystal sandwiched between, wherein the direction of uniaxial orientation of the upper and lower substrates is either parallel or anti-parallel. The temperature change of the retardation value of the liquid crystal device is reduced by changing the orientation state of liquid crystal molecules so as to compensate for change in the birefringence of the liquid crystal composition due to changes in temperature. Accordingly, deterioration of contrast owing to the temperature properties of the Δn of the liquid crystal composition is reduced.

### BACKGROUND OF THE INVENTION

1. Field of the Invention

The present invention relates to a liquid crystal device using nematic liquid crystal, a liquid crystal display device, and a display panel using multiple liquid crystal display devices.

2. Description of the Related Art

Conventionally, TN (Twisted Nematic) oriented devices wherein the rubbing direction of upper and lower substrates of liquid crystal cells have been 90° rotated are normally used for the nematic liquid crystal orientation, but other methods have also been long known, such as ECB (Electrically Controlled Birefringence) wherein rubbing processing is performed for the upper and lower substrates in anti-parallel directions and nematic liquid crystal is sandwiched between two upper and lower electrode substrates, and orientation wherein rubbing processing has been performed in the same direction (splay orientation). Also, a method wherein voltage is applied to splay orientation rubbed in the same direction in particular to cause orientation change in the bend direction, thereby improving response speed, has been reported by Bos et al. in 1983 (a cell: see FIG. 1).

Research for improving angle of visibility properties by performing phase compensation for such bend orientation cells has been reported by Uchida et al. in 1992 (OCB: Optically Compensated Birefringence) cells. FIG. 2 shows a representative configuration of such OCB cells. In the figure, reference numerals 71 and 75 denote polarizers, 72 and 73 denote phase compensator plates, and 74 denotes a liquid crystal cell.

Such a bend orientation type nematic liquid crystal improves and speeds up responsivity by suppressing the backflow phenomena in the response of the liquid crystal.

However, There are several problems in the event of using such ECB, Splay, and OCB modes in display devices in actual practice. One of the problems has been the contrast deteriorates with change in temperature in comparison to that at optimal temperature, due to the temperature properties of the refractive index anisotropy of the liquid crystal composition (hereafter represented by “Δn”).

### SUMMARY OF THE INVENTION

Accordingly, it is an object of the present invention to solve the aforementioned problems with the conventional art, and to provide a liquid crystal display device and display panel with excellent display properties by reducing deterioration in contracts due to temperature properties of Δn of the liquid crystal composition.

To this end, the present invention is a liquid crystal display device and display panel comprising: two substrates; and nematic liquid crystal sandwiched between the substrates; wherein the direction of uniaxial orientation of upper and lower substrates is either parallel or anti-parallel; and wherein temperature change of the retardation value of the liquid crystal device is reduced by changing the orientation state of liquid crystal molecules so as to compensate for change in the birefringence of the liquid crystal composition due to changes in temperature.

The present invention is also a display panel comprising an array of a plurality of the liquid crystal display devices.

Specifically, using a liquid crystal composition wherein nematic liquid crystal having Δn at 30° C. is 0.150 or more as the primary component thereof, and having the pre-tilt angle of liquid crystal molecules at 30° C. at the substrate interface to be 10° or more and 45° or less, allows the change in the above-described refractive index anisotropy to be compensated for.

The orientation of the upper and lower substrates according to the present invention is preferably provided by rubbing an organic orientated film having a vertical or high pre-tilt angle, thereby providing uniaxial orientation.

In the event of using switching devices or the like for driving the liquid crystal device according to the present invention, black is preferably displayed by performing phase compensation, and particularly, a normally-white mode wherein the high-voltage side of the driving voltage is preferably used as black.

Further objects, features and advantages of the present invention will become apparent from the following description of the preferred embodiments with reference to the attached drawings.

### BRIEF DESCRIPTION OF THE DRAWINGS

FIG. 1 is a schematic cross-sectional diagram representing a π cell with the splay orientation method;

FIG. 2 is a schematic cross-sectional diagram representing an OCB cell subjected to phase compensation;

FIG. 3 is a graph representing temperature properties of the Δn of the liquid crystal composition;

FIG. 4 is a graph illustrating pre-tilt angle change due to the temperature of the liquid crystal composition;

FIG. 5 is a graph illustrating the properties of voltage and retardation of a liquid crystal device according to a first embodiment of the present invention;

FIG. 6 is a graph illustrating the properties of voltage and retardation of a liquid crystal device according to a second comparative example;

FIG. 7 is a schematic cross-sectional diagram representing one pixel worth according to an embodiment of a liquid crystal device according to the present invention;

FIG. 8 is a plan schematic diagram of a display panel comprising the liquid crystal display device shown in FIG. 7;

FIG. 9 is a diagram illustrating an example of voltage waveform to be applied to the driver shown in FIG. 8;

FIG. 10 is a graph illustrating the relation between the pre-tilt angle of the liquid crystal composition and temperature change of contrast; and

FIG. 11 is a graph illustrating the relation between temperature change of contrast and the Δn of the liquid crystal composition.

### DESCRIPTION OF THE PREFERRED EMBODIMENTS

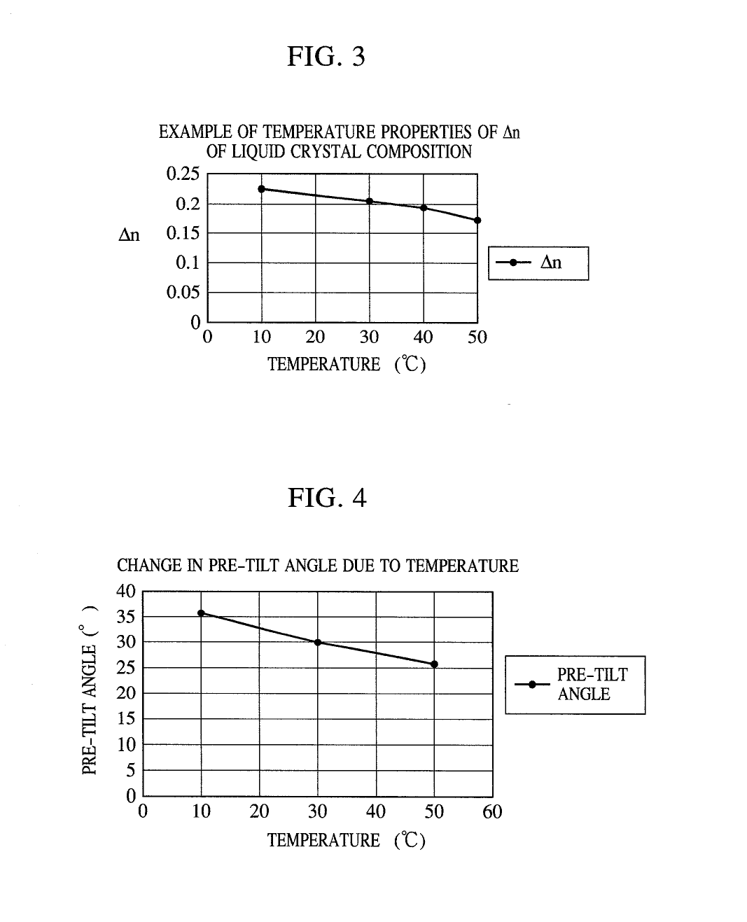

The present inventors have discovered that sandwiching nematic liquid crystal between liquid crystal cell wherein the upper and lower substrates have been subjected to parallel or anti-parallel rubbing processing of an organic oriented film having vertical or high pre-tilt changes the orientation state such that the temperature properties of the Δn of the liquid crystal composition are mutually cancelled, and thus have reached the present invention. It is known that normally the temperature properties of the Δn of liquid crystal compositions gradually is small at high temperatures and gradually increases as temperatures are lowered. FIG. 3 shows the temperature properties of the Δn of the liquid crystal composition used with the present embodiment.

FIG. 3 is a graph illustrating the temperature change of the Δn of the liquid crystal, with temperature as the X axis and refractive index anisotropy Δn as the vertical axis. As shown in the figure, the Δn of the liquid crystal is high in the event that the temperature is low, and is low in the event that the temperature is high. Generally, all compounds referred to as liquid crystal exhibit such temperature change, regardless of the type thereof. The present inventors noted that there is the need to devise some way to compensate for the Δn which drops at high temperatures, and studied if such a way could be devised.

Now, a phenomena was observed by the present inventors wherein sandwiching such general liquid crystal compositions between liquid crystal cells subjected to rubbing processing of an organic oriented film having vertical or extremely high pre-tilt causes reversible change of the pre-tilt angle according to temperature. FIG. 4 shows an example of this phenomena.

FIG. 4 is a graph with temperature as the X axis and the pre-tilt angle of liquid crystal molecules as the vertical axis. As shown in the figure, the liquid crystal exhibits a high pre-tilt angle in the event that the temperature is on the low side, and exhibits a low pre-tilt angle in the event that the temperature is on the high side. That is to say, it has been found that arranging so that the pre-tilt angle becomes smaller at higher temperatures where the Δn of the liquid crystal composition becomes smaller, and the pre-tilt angle becomes greater at lower temperatures where the Δn of the liquid crystal composition becomes greater allows the temperature dependency of the retardation value of the liquid crystal device to be markedly reduced.

The present embodiment will be described later with a bend orientation liquid crystal device. As described above with reference to FIG. 3, the value of Δn of normal liquid crystal molecules differs according to the temperature, but the orientation direction of the molecules themselves hardly changes due to such temperature changes. However, changes in temperature causes the Δn of each molecule to differ. The retardation value R implies the sum of Δn of the molecules of the liquid crystal sandwiched between both substrates in the direction of the substrates, and is defined by R=Δnd (wherein d represents the thickness of the liquid crystal). In the present embodiment, the reason that a bend orientation liquid crystal device is used is because control of the retardation value is particularly noted with bend orientation liquid crystal devices. Conversely, with TN liquid crystal devices, there is no need to design the device taking the retardation value into consideration. Accordingly, the present embodiment is not applied to TN liquid crystal devices, but rather is suitably used with, for example, splay orientation or ECB type liquid crystal devices wherein control of the retardation value is noted.

Also, though the present embodiment will be described later with reference to an arrangement using a liquid crystal device as a display device, but the present invention may also be applied to other art using switching actions of liquid crystal molecules, such as liquid crystal devices necessitating light valve functions, for example.

As with the present embodiment, devising some way to compensate for the Δn of the liquid crystal which changes with temperature, more specifically changing the pre-tilt angle according to temperature so as to compensate for the Δn, allows the temperature change of the retardation value to be reduced.

With the present embodiment, a liquid crystal device was used as a display device. A phase compensator plate was used to obtain high contrast, as shown in FIG. 2. The phase compensator plate was set perpendicular to the orientation direction (the uniaxial direction). It was found that using such an orienting means wherein the orientation direction of the phase compensator plate is taken into consideration not only reduces change in retardation, but also markedly reduces change in display capabilities, more specifically, temperature change of contrast.

Further, it was found that designing the pre-tilt value of the liquid crystal device appropriately allows the fluctuation in contrast to be optimized. Setting the pre-tilt angle at 30° C. to be 10° or more allows the fluctuation of the retardation value at temperatures of 30° C. or lower to be markedly reduced. In this case, an arrangement may be used wherein the contrast from around room temperature (e.g., 30° C.) to low temperatures is made to be as uniform as possible, as with reflection type displays.

Further, setting the pre-tilt angle at 30° C. to be 30° or more allowed the fluctuation of the retardation value to be markedly reduced at temperatures from the lower side to the higher side. This arrangement can be used with liquid transmitting crystal displays having a back light.

Also, setting the pre-tilt angle of interest over a certain angle, over 45° in this case for example, caused the degree of change in orientation to be extremely great and accordingly retardation fluctuation at the lower temperatures became great, which lead to deterioration in contrast. Accordingly, it has been found that the pre-tilt angle should be used at 45° or smaller.

Further, the present embodiment is extremely effective with cases of using liquid crystal material or liquid crystal compositions mixed with other materials for practical purposes, having a Δn of 0.150 or more. The reason is that the greater that absolute value of the Δn of liquid crystal compositions is, the greater the amount of temperature change is, and the temperature change of contrast due to this change is also marked.

Accordingly, the present inventors found that the present embodiment is suitably used with cases wherein liquid crystal material or liquid crystal compositions having great absolute values for the Δn are used.

Describing in further detail the manner in which the present inventors discovered this, the temperature properties of Δn generally changed around 10% to 20% in changes of temperature to 10° C. and 50° C. with the Δn at 30° C. as a reference. The Δn value at 30° C. was used as the reference Δn for sake of evaluating the contrast capabilities of display devices. FIG. 11 is a graph illustrating the relation between temperature change of contrast (the difference between contrast at 30° C. and contrast at 10° C.; hereafter referred to as “contrast difference”) and the Δn of the liquid crystal composition. The measurement results of the liquid crystal device according to the present embodiment comparing liquid crystal compositions with differing Δn shows the contrast difference to be great with liquid crystal devices using liquid crystal compositions having Δn of 0.140 or higher, and particularly having Δn of 0.150 or higher, as shown in FIG. 11, and that the present embodiment is effective with arrangement using liquid crystal compositions having Δn of 0.150 or higher.

Incidentally, the present embodiment can be also applied to cases wherein a single liquid crystal material having a Δn value which exceeds a particular value under temperature change is selected and used, instead of using liquid crystal compositions.

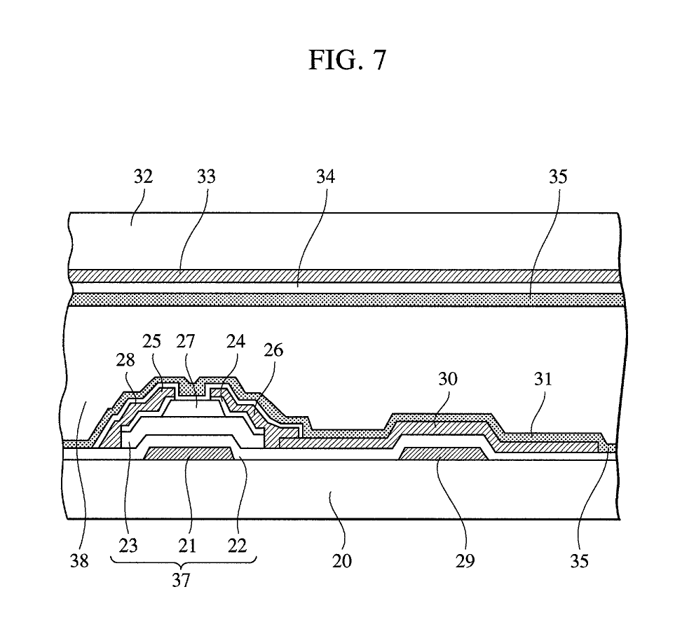

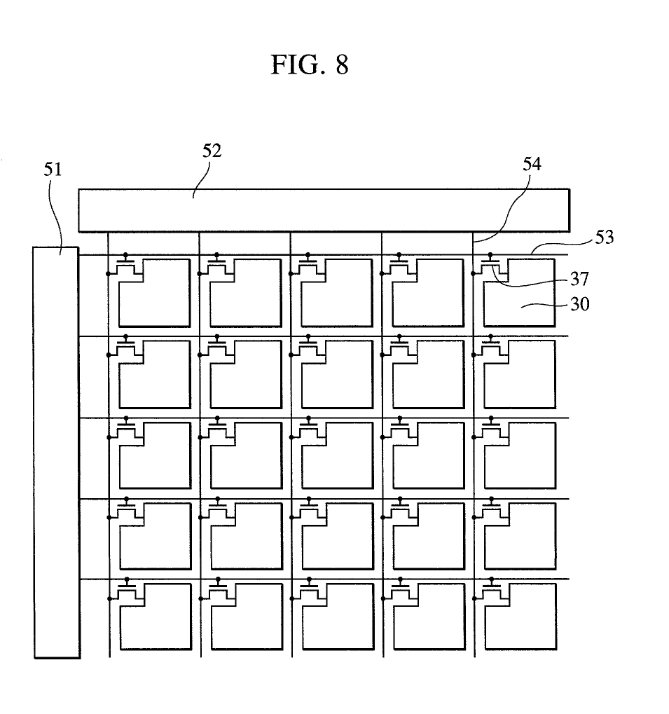

Next, a schematic cross-sectional diagram of one pixel of the liquid crystal device according to the present embodiment is shown in FIG. 7, and a plan view schematic diagram of a display panel with the liquid crystal device built in is shown in FIG. 8. The present liquid crystal device is an active matrix liquid crystal device where TFTs are used as switching devices, and as shown in FIG. 8, multiple pixel electrodes 30 are arrayed in a matrix, the gate electrodes of the TFTs 37 situated at each pixel electrode 30 are connected to scanning signal lines 53, the source electrodes are each wired to the information signal lines 54 to form a matrix wiring, scanning selection signals (ON signals for the TFTs 37) are sequentially applied from the scanning signal applying circuit 51 to the scanning signal lines 53 and information signals having certain gradient display information are applied from the information signal applying circuit 52 in a manner synchronous with the scanning selection signals and thus written to the pixel electrodes 30 of the selected lines, and a predetermined voltage is applied to the liquid crystal layer, thereby making display.

In FIG. 7, reference numeral 20 denotes a substrate, 21 denotes a gate electrode, 22 denotes a gate insulating film, 23 denotes a semiconductor layer, 24 denotes an ohmic contact layer, 25 denotes a source electrode, 26 denotes a drain electrode, 27 denotes an insulating layer, 28 denotes a passivation film, 29 denotes a holding capacity electrode, 30 denotes a pixel electrode, 31 denotes a horizontal oriented film, 32 denotes a substrate, 33 denotes a shared electrode, 34 denotes an insulating layer, 35 denotes an oriented layer providing uniaxiality, 37 denotes a TFT, and 38 denotes a liquid crystal layer.

With the liquid crystal device shown in FIG. 7, normally substrates having transparency such as glass or plastic or the like are used for the substrate 20 in the case of transmitting types, and non-transparent substrates such as silicon substrates or the like may be used for reflecting types. The pixel electrode 30 and shared electrode 33 are both formed to a thickness of around 150 nm of a transparent electroconductive material such as ITO or the like using vacuum film forming for example. In the case of a reflecting liquid crystal device, the arrangement the pixel electrode 30 may be formed of a metal with high reflectivity to also serve as a reflecting plate. Normally, amorphous (a-) Si is used for the semiconductor layer 23, with monosilane diluted in hydrogen (SiH₄) being deposited on a glass substrate at a temperature of around 300° C. to a thickness of approximately 200 nm, using glow discharge decomposition (plasma CVD), for example. Other examples suitably used include polycrystalline (p-) Si. Further, for the ohmic contact layer 24, an n+a-Si layer doped with phosphorous is used, for example. Silicon nitride (SiNx) is used for the gate insulating film 22, formed by glow discharge decomposition for example. Further, metal such as Al or the like is normally used for the gate electrode 21, source electrode 25, drain electrode 26, holding capacity electrode 29, lines, and the like. Regarding the holding capacity electrode 29, there are cases wherein a transparent electroconductive material such as ITO or the like is used in cases where the area is great. Ta₂O₅ is used for the insulating layer 34, and is deposited to a thickness of around 100 nm by vacuum film forming, for example. Further, the insulating layer 27 and passivation film 28 are preferably formed of an insulating film such as silicon nitride or the like.

The following is a description of specific embodiments, but the present invention is by no means restricted to these. (First through fourth embodiments, and first and second comparative examples)

<Fabricating Parallel Rubbing Cells>

Onto a glass substrate upon which ITO had been applied by vapor deposition and then patterned, perpendicular orientation film forming solution (product name JALS2022, manufactured by JSR) was applied at a predetermined concentration by spin coating. This was pre-baked for 2 minutes at 80° C., and the baked for 60 minutes at 200° C. This was subjected to rubbing processing using a cotton flocked fabric (rubbing roller diameter 80 mm, roller rotations of 1000 rpm, substrate surface depressing of 12 mm, and substrate feeding speed of 10 mm/s). Two electrode substrates thus treated were placed one against the other with a spacer 6μ in diameter and a sealing agent introduced therebewteen such that the rubbing direction of the upper and lower substrates were parallel, thereby forming a liquid crystal cell.

<Fabricating Anti-parallel Rubbing Cells>

Onto a glass substrate upon which ITO had been applied by vapor deposition and then patterned, perpendicular orientation film forming solution (product name JALS2022, manufactured by JSR) was applied at a predetermined concentration by spin coating. This was pre-baked for 2 minutes at 80° C., and the baked for 60 minutes at 200° C. This was subjected to rubbing processing using a cotton flocked fabric (rubbing roller diameter 80 mm, roller rotations of 1000 rpm, substrate surface depressing of 1.2 mm, and substrate feeding speed of 10 mm/s). Two electrode substrates thus treated were placed one against the other with a spacer 6μ in diameter and a sealing agent introduced therebewteen such that the rubbing direction of the upper and lower substrates were anti-parallel, thereby forming a liquid crystal cell.

A liquid crystal composition (product name CF-1783, manufactured by SEIMI CHEMICAL) was injected at room temperature under reduced pressure into the cells thus formed, thereby forming liquid crystal devices.

Pre-tilt was optimized by adjusting the changing the concentration of the oriented film solution to change the thickness of the oriented film. The oriented film thickness and the pre-tilt angle at 30° C. are shown in Tables 1 and 2.

<Evaluation of the Cells>

(Preparatory Processing for Transposition to a Bend State)

Voltage of 10 V was applied to the parallel cell thus fabricated so as to cause transposition from the splay state to the bend state. Though 10 V was used here as an example, the voltage may be varied between 1 V to 10 V.

(Measurement of the Relation Between the R Value and the Voltage)

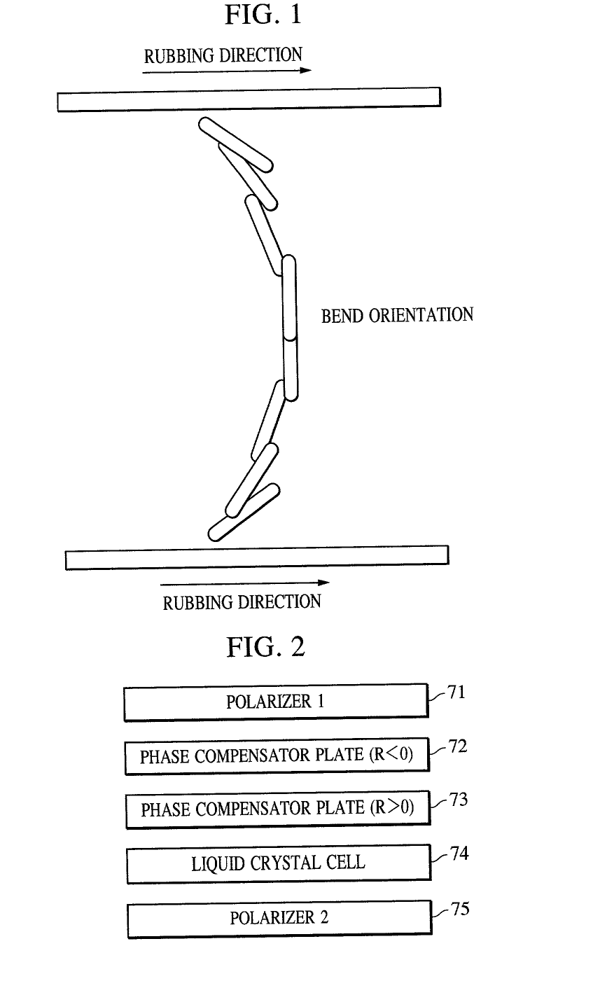

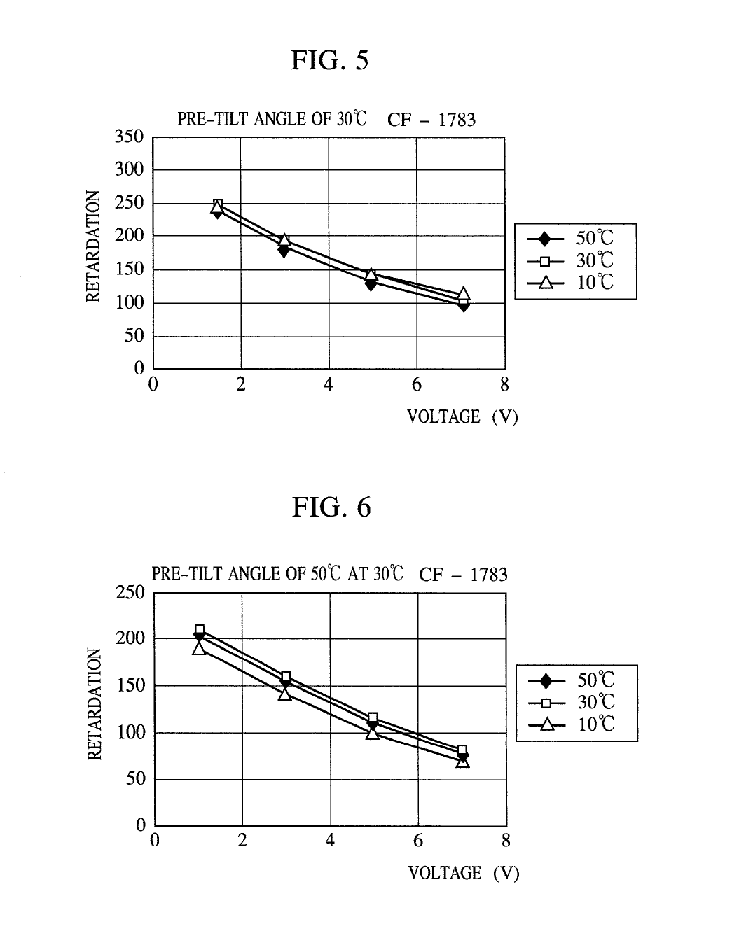

Measurement of the relation between the retardation value R and the voltage was measured using a Berek compensator, while applying 60 Hz rectangle waves in this bend state. FIG. 5 shows one example thereof, wherein the pre-tilt angle at 30° C. was 30°. Now, a phase compensator plane equivalent to the reduction value at the time of applying 5 V (a plate wherein complete black, i.e., non-transparency is achieved at the time of applying 5 V) was used, and phase compensating was performed with the phase compensating axis of the compensator plate orthogonal to the rubbing direction of the liquid crystal cell. This was introduced between orthogonal polarizers, and the contrast was evaluated. This evaluation was made by measuring the contrast (transmittance of white/transmittance of black) at 50° C., 30° C., and 10° C. The results are shown in FIG. 1.

TABLE 1
Relation of pre-tilt angle and temperature change of
contrast

| | First | | | | | Second |
|---|---|---|---|---|---|---|
| | compar- | First | Second | Third | Fourth | compar- |
| | ative | embod- | embod- | embod- | embod- | ative |
| | example | iment | iment | iment | iment | example |
| Oriented | 100 | 150 | 200 | 350 | 400 | 450 |
| film | | | | | | |
| thickness | | | | | | |
| (Å) | | | | | | |
| Pre-tilt | 5 | 10 | 25 | 30 | 45 | 50 |
| angle (°) | | | | | | |
| at 30° C. | | | | | | |
| Contrast | | | | | | |
| fluctuation | | | | | | |
| 50° C. | 40 | 100 | 130 | 150 | 100 | 80 |
| 30° C. | 150 | 150 | 150 | 150 | 100 | 80 |
| 10° C. | 25 | 150 | 150 | 150 | 80 | 40 |

As can be understood from Table 1, contrast fluctuations of the first embodiment were improved as compared to the first comparative example at low temperatures (10° C.). Also, contrast fluctuations of the third embodiment were improved as compared to the first embodiment example at high temperatures (50° C.). With the second comparative example, there were contrast fluctuations at the lower temperature side as compared to the fourth embodiment.

Anti-parallel cells corresponding to these embodiments and comparative examples were used and pre-tilt angle fluctuations according to temperature were monitored. The results are shown in Table 2.

TABLE 2
Temperature change of pre-tilt angle (anti-parallel rubbing
cells)

| | First | | | | | Second |
|---|---|---|---|---|---|---|
| | compar- | First | Second | Third | Fourth | compar- |
| | ative | embod- | embod- | embod- | embod- | ative |
| | example | iment | iment | iment | iment | example |
| Oriented | 100 | 150 | 200 | 350 | 400 | 450 |
| film | | | | | | |
| thickness | | | | | | |
| (Å) | | | | | | |
| Pre-tilt | 5 | 10 | 25 | 30 | 45 | 50 |
| angle (°) | | | | | | |
| at 30° C. | | | | | | |
| Pre-tilt | | | | | | |
| angle (°) | | | | | | |
| fluctuation | | | | | | |
| 50° C. | 5 | 9 | 22 | 26 | 40 | 46 |
| 30° C. | 5 | 10 | 25 | 30 | 45 | 50 |
| 10° C. | 6 | 12 | 28 | 36 | 51 | 56 |

Comparing the embodiments with the first comparative example, it was found that the pre-tilt fluctuates so as to compensate for the fluctuations of the Δn of the liquid crystal. Also, with the second comparative example, pre-tilt change exceeding the temperature change of the retardation value of the liquid crystal device occurred at low temperatures (10° C.), thus exhibiting deterioration in contrast. FIG. 6 shows the change in retardation values of the parallel cell in the bend state with the second comparative example.

Further, with the third embodiment, phase compensation was performed at the low-voltage side (1.2 V), taking normally-black into consideration. Contrast fluctuations were constantly 80 between 50° C. to 10° C. Incidentally, the other embodiments and comparative examples were also subjected to the same phase compensation, exhibiting no contrast fluctuation between 50° C. to 10° C. However, the third embodiment maintained higher contrast than the other embodiments throughout this temperature range.

<Relation of Contrast Temperature Change and Δn of Liquid Crystal Composition>

A liquid crystal composition was prepared by mixing CF-1783 and a liquid crystal composition manufactured by CHISSO CORPORATION (product name KN-5030) according to component ratios (percentage by weight) shown in Table 3, and the Δn at 30° C. was measured. The results are shown in Table 3.

TABLE 3
Component ratio of liquid crystal compositions
and Δn at 30° C.

| Composition | A | B | C | D | E | F | G |
|---|---|---|---|---|---|---|---|
| KN-5030 | 90 | 80 | 70 | 60 | 50 | 40 | 20 |
| CF-1783 | 10 | 20 | 30 | 40 | 50 | 60 | 80 |
| Δn at 30° C. | 0.13 | 0.14 | 0.15 | 0.16 | 0.17 | 0.18 | 0.19 |

These liquid crystal compositions A through G were injected into parallel rubbing cells fabricated according to the third embodiment, and the contrast temperature change was measured at 30° C. and 10° C. The results are shown in FIG. 11. The liquid crystal was driven, and the transmittance at 7 V for displaying black (non-transparent) and the transmittance at 2 V for displaying white (transparent) were measured and the contrast was measured based on the difference of the two. It can be understood from FIG. 11 that the means of the present invention are effective with liquid crystal compositions having Δn of 0.150 or higher.

(Fifth Embodiment)

<Evaluation of Liquid Crystal Device Using Switching Devices>

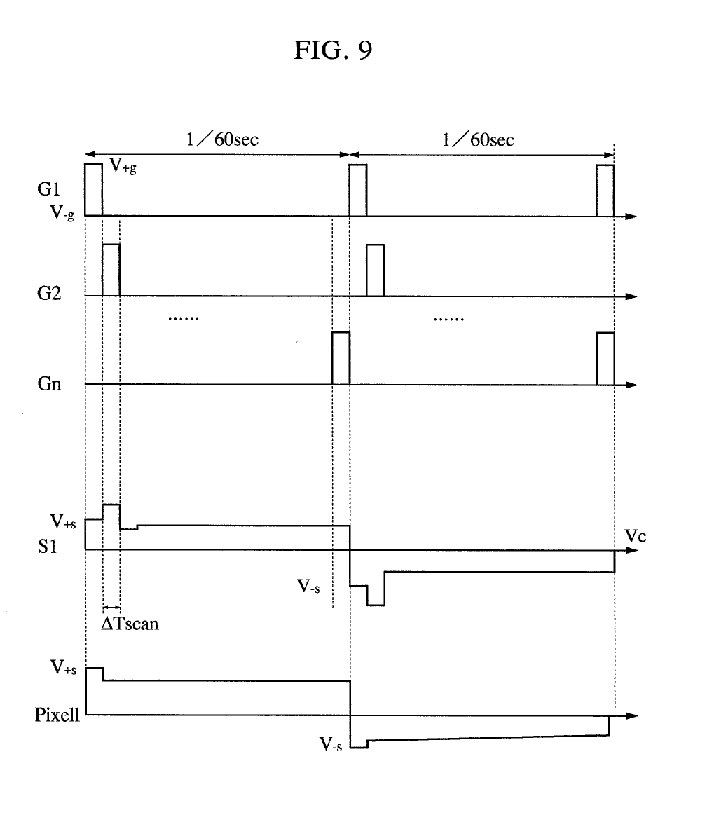

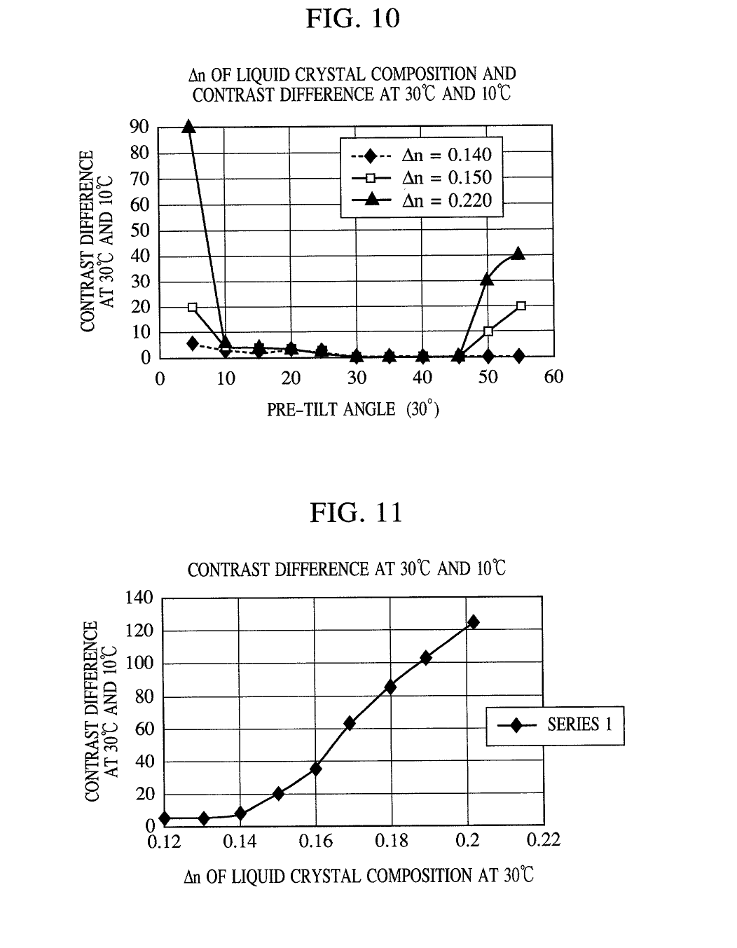

A substrate having a TFT configuration such as shown in FIG. 7 was fabricated. The oriented film was formed according to the conditions of the third embodiment, and printing was performed only at the time of applying the oriented film. Data and gate drivers were mounted to this substrate, as shown in FIG. 8. Liquid crystal device display was made by applying waveforms shown as examples in FIG. 9. The contrast was measure by applying voltage at the time of displaying black (7 V applied to the data lines) and at the time of displaying white (1 V applied to the data lines). The results showed that the contrast was constant at 100 from 50° C. to 10° C.

(Third and Fourth Comparative Example)

Oriented film printing was performed under the conditions of the first and second comparative examples, and TFT substrates having the same configuration as the fifth embodiment were fabricated. Measuring contrast in the same manner as with the fifth embodiment shows that the contrast of the third comparative example was 100 at 50° C., 50 at 30° C., and 20 at 10° C., thus exhibiting greatly differing contrast at different temperatures. The fourth comparative example also exhibited greatly differing contrast according to temperature, as with the third comparative example.

Accordingly, as described above, temperature change of contrast can be markedly alleviated by changing the orientation state according to temperature so as to compensate for the temperature priorities of the Δn of the liquid crystal, and thus a liquid crystal device with excellent display properties can be provided. While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modification and equivalent structures and functions.

What is claimed is:

1. A liquid crystal device comprising:
two substrates; and
nematic liquid crystal sandwiched between said substrates;
wherein the direction of uniaxial orientation of upper and lower substrates is either parallel or anti-parallel;
and wherein temperature change of the retardation value of said liquid crystal device is reduced by changing the orientation state of liquid crystal molecules so as to compensate for change in the birefringence of said liquid crystal composition due to changes in temperature.

2. A liquid crystal device according to claim 1, wherein the refractive index anisotropy of a liquid crystal composition having said nematic liquid crystal as the primary component thereof at 30° C. is 0.150 or more, and the pre-tilt angle of liquid crystal molecules at 30° C. at the substrate interface is 10° or more and 45° or less.

3. A liquid crystal device according to either claim 1 or 2, wherein the orientation of said upper and lower substrates is provided by an organic orientated film having a vertical or high pre-tilt angle, providing uniaxiality.

4. A liquid crystal device according to any of the claims 1 through 3, wherein switching devices are used for driving.

5. A liquid crystal device according to any of the claims 1 through 4, wherein black is displayed by performing phase compensation.

6. A liquid crystal device according to any of the claims 1 through 5, using a normally-white mode wherein the high-voltage side of the driving voltage is used as black.

7. A display panel comprising an array of a plurality of liquid crystal devices, each of said liquid crystal devices comprising:
two substrates; and
nematic liquid crystal sandwiched between said substrates;
wherein the direction of uniaxial orientation of upper and lower substrates is either parallel or anti-parallel;
wherein temperature change of the retardation value of said liquid crystal device is reduced by changing the orientation state of liquid crystal molecules so as to compensate for change in the birefringence of said liquid crystal composition due to changes in temperature.

8. A liquid crystal device according to claim 1, wherein said liquid crystal device is a liquid crystal display device.

9. A liquid crystal device according to claim 1, wherein said liquid crystal device is an ECB (Electrically Controlled Birefringence) type.

10. A liquid crystal device according to claim 1, wherein said liquid crystal device is a splay orientation type.

11. A liquid crystal device according to claim 1, wherein said liquid crystal device is a bend orientation type.
